(19) United States
(12) Patent Application Publication
(10) Pub. No.: US 2026/0333132 A1
(43) Pub. Date: Oct. 22, 2026

(54) DYNAMIC SCS NEGOTIATION PROCEDURE

(71) Applicant: Samsung Electronics Co., Ltd., Suwon-si (KR)

(72) Inventors: Yue Qi, Plano, TX (US); Rubayet Shafin, Frisco, TX (US); Peshal Nayak, Plano, TX (US); Vishnu Vardhan Ratnam, Frisco, TX (US); Boon Loong Ng, Plano, TX (US); Bilal Sadiq, Plano, TX (US)

(21) Appl. No.: 19/646,322

(22) Filed: Apr. 13, 2026

Related U.S. Application Data
(60) Provisional application No. 63/791,102, filed on Apr. 18, 2025.
(60) Provisional application No. 63/791,170, filed on Apr. 18, 2025.
(60) Provisional application No. 63/793,364, filed on Apr. 23, 2025.
(60) Provisional application No. 63/814,203, filed on May 29, 2025.
(60) Provisional application No. 63/819,355, filed on Jun. 6, 2025.

(51) Int. Cl. H04W 28/18; H04L 47/2441; H04W 28/02

(52) U.S. Cl. CPC H04W 28/18; H04L 47/2441; H04W 28/0215

(57) ABSTRACT

Methods and systems for a dynamic SCS negotiation procedure. A method includes transmitting, to an associated AP device, a request frame that includes a plurality of quality of service (QoS) profiles Each QoS profile of the plurality of QoS profiles includes one or more QoS characteristics elements and is identified by a unique QoS profile identifier (ID). The plurality of QoS profiles are grouped within the request frame. The method also includes receiving, from the AP device, a response frame where the response frame indicating SUCCESS or REJECT of one or more of the plurality of QoS profiles.

### CROSS-REFERENCE TO RELATED APPLICATIONS AND CLAIM OF PRIORITY

The present application claims priority to U.S. Provisional Patent Application No. 63/791,102, filed on Apr. 18, 2025, Provisional Patent Application No. 63/791,170, filed on Apr. 18, 2025, Provisional Patent Application No. 63/793,364, filed on Apr. 23, 2025, Provisional Patent Application No. 63/814,203, filed on May 29, 2025, Provisional Patent Application No. 63/819,355, filed on Jun. 6, 2025. The contents of the above-identified patent documents are incorporated herein by reference.

### TECHNICAL FIELD

The present disclosure relates generally to wireless communication systems, more specifically, the present disclosure relates to a system and method for a dynamic SCS negotiation procedure.

### BACKGROUND

Wireless Local Area Network (WLAN) technology allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

The present disclosure relates generally to wireless communication systems and, more specifically, the present disclosure relates to a system and method for a dynamic SCS negotiation procedure.

In one embodiment, a method performed by a non-access point (AP) station (STA) is provided. The method includes transmitting, to an associated AP device, a request frame that includes a plurality of quality of service (QoS) profiles. Each QoS profile of the plurality of QoS profiles includes one or more QoS characteristics elements and is identified by a unique QoS profile identifier (ID). The plurality of QoS profiles are listed within the request frame. The method also includes receiving, from the AP device, a response frame where the response frame indicating SUCCESS or REJECT of one or more of the plurality of QoS profiles.

In one embodiment, a method performed by an access point (AP) device is provided. The method includes receiving, from an associated non-AP station (STA), a request frame that includes a plurality of quality of service (QoS) profiles. Each QoS profile of the plurality of QoS profiles includes one or more QoS characteristics elements and is identified by a unique QoS profile identifier (ID). The plurality of QoS profiles are listed within the request frame. The method also includes transmitting, to the non-AP STA, a response frame where the response frame indicating SUCCESS or REJECT of one or more of the plurality of QoS profiles.

In another embodiment, an electronic device is provided. The electronic device includes a transceiver, and a processor operably coupled to the transceiver. The processor is configured to cause the electronic device to transmit, to an associated AP device, a request frame that includes a plurality of quality of service (QoS) profiles. Each QoS profile of the plurality of QoS profiles includes one or more QoS characteristics elements and is identified by a unique QoS profile identifier (ID). The plurality of QoS profiles are listed within the request frame. The processor is also configured to cause the electronic device to receive, from the AP device, a response frame where the response frame indicating SUCCESS or REJECT of one or more of the plurality of QoS profiles.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example access point (AP) according to embodiments of the present disclosure;

FIG. 2B illustrates an example station (STA) according to embodiments of the present disclosure;

FIG. 3 illustrates an example dynamic stream classification service (D-SCS) descriptor element supporting a dynamic SCS negotiation procedure according to embodiments of the present disclosure;

FIG. 4 illustrates an example D-SCS indication field supporting a dynamic SCS negotiation procedure according to embodiments of the present disclosure;

FIG. 5 illustrates an example D-SCS descriptor list supporting a dynamic SCS negotiation procedure according to embodiments of the present disclosure;

FIG. 6 illustrates an example D-SCS descriptor list supporting a dynamic SCS negotiation procedure according to embodiments of the present disclosure;

FIG. 7 illustrates an example quality of service (QoS) profile information supporting a dynamic SCS negotiation procedure according to embodiments of the present disclosure;

FIG. 8 illustrates an example QoS profile information field supporting a dynamic SCS negotiation procedure according to embodiments of the present disclosure;

FIG. 9 illustrates an example mixed SCS and D-SCS request frame supporting a dynamic SCS negotiation procedure according to embodiments of the present disclosure;

FIG. 10 illustrates an example D-SCS request frame supporting a dynamic SCS negotiation procedure according to embodiments of the present disclosure;

FIG. 11 illustrates an example QoS profile information field in an SCS status duple supporting a dynamic SCS negotiation procedure according to embodiments of the present disclosure;

FIG. 12 illustrates an example QoS profile information field as one of a SCS status duple supporting a dynamic SCS negotiation procedure according to embodiments of the present disclosure;

FIG. 13 illustrates an example SCS and D-SCS response frame supporting a dynamic SCS negotiation procedure according to embodiments of the present disclosure;

FIG. 14 illustrates an example D-SCS status list supporting a dynamic SCS negotiation procedure according to embodiments of the present disclosure;

FIG. 15 illustrates an example D-SCS response frame supporting a dynamic SCS negotiation procedure according to embodiments of the present disclosure;

FIG. 16 illustrates an example QoS characteristics supporting a dynamic SCS negotiation procedure according to embodiments of the present disclosure;

FIG. 17 illustrates an example QoS profile indication with DPS mode supporting a dynamic SCS negotiation procedure according to embodiments of the present disclosure;

FIG. 18 illustrates an example flow chart of a method performed by a non-access point station for a dynamic SCS negotiation procedure according to embodiments of the present disclosure; and

FIG. 19 illustrates an example flow chart of a method performed by an access point device for a dynamic SCS negotiation procedure according to embodiments of the present disclosure.

### DETAILED DESCRIPTION

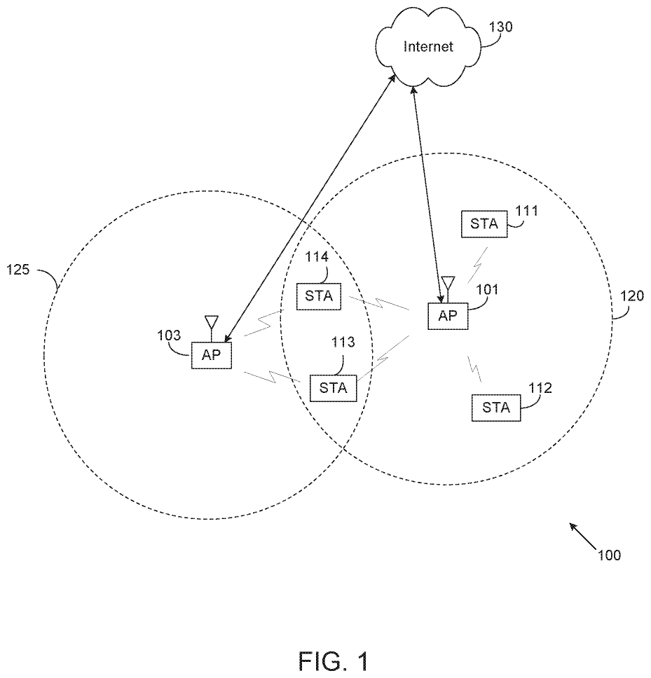

FIG. 1 through FIG. 19, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE 802.11-2020, “Wireless LAN Medium Access Control (MAC) and Physical Layer (PHY) Specification.”

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes AP devices 101 and 103. The AP devices 101 and 103 communicate with at least one network 130, such as the Internet, a proprietary Internet Protocol (IP) network, or other data network. The AP device 101 provides wireless access to the network 130 for a plurality of stations (STAs) 111-114 within a coverage area 120 of the AP device 101. The AP devices 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP device also contends for the wireless channel, the AP device may also be referred to as a STA (e.g., an AP device STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP device or contends for a wireless channel in a WLAN, whether the STA is a mobile device (such as a mobile telephone or smartphone) or is normally considered a stationary device (such as a desktop computer, AP device, media player, stationary sensor, television, etc.). This type of STA may also be referred to as a non-AP STA.

In various embodiments of this disclosure, each of the AP devices 101 and 103 and each of the STAs 111-114 may be an MLD. In such embodiments, AP devices 101 and 103 may be AP device MLDs, and STAs 111-114 may be non-AP MLDs. Each MLD is affiliated with more than one STA. For convenience of explanation, an AP device MLD is described herein as affiliated with more than one AP device (e.g., more than one AP device STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with AP devices, such as the coverage areas 120 and 125, may have other shapes, including irregular shapes, depending upon the configuration of the AP devices and variations in the radio environment associated with natural and man-made obstructions.

As described in more detail below, one or more of the AP devices may include circuitry and/or programming for supporting dynamic QoS profile switch in dynamic SCS. Although FIG. 1 illustrates one example of a wireless network 100, various changes may be made to FIG. 1. For example, the wireless network 100 could include any number of AP devices and any number of STAs in any suitable arrangement. Also, the AP device 101 could communicate directly with any number of STAs and provide those STAs with wireless broadband access to the network 130. Similarly, each AP device 101-103 could communicate directly with the network 130 and provide STAs with direct wireless broadband access to the network 130. Further, the AP devices 101 and/or 103 could provide access to other or additional external networks, such as external telephone networks or other types of data networks.

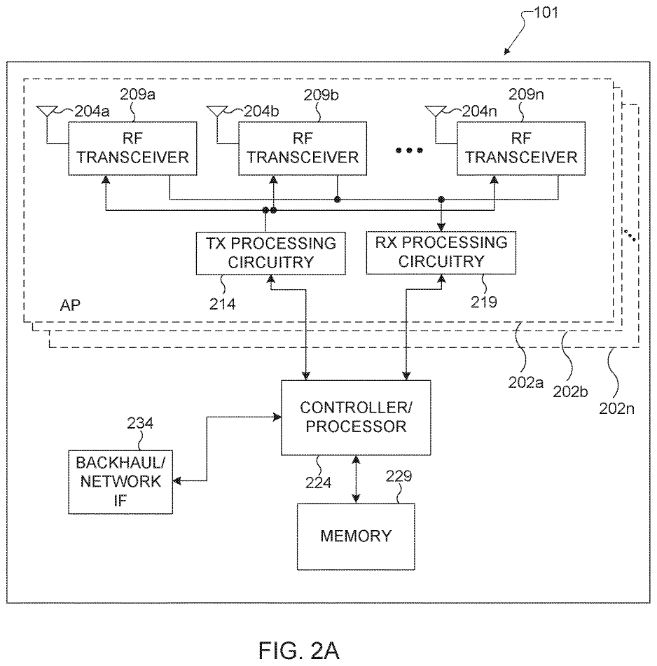

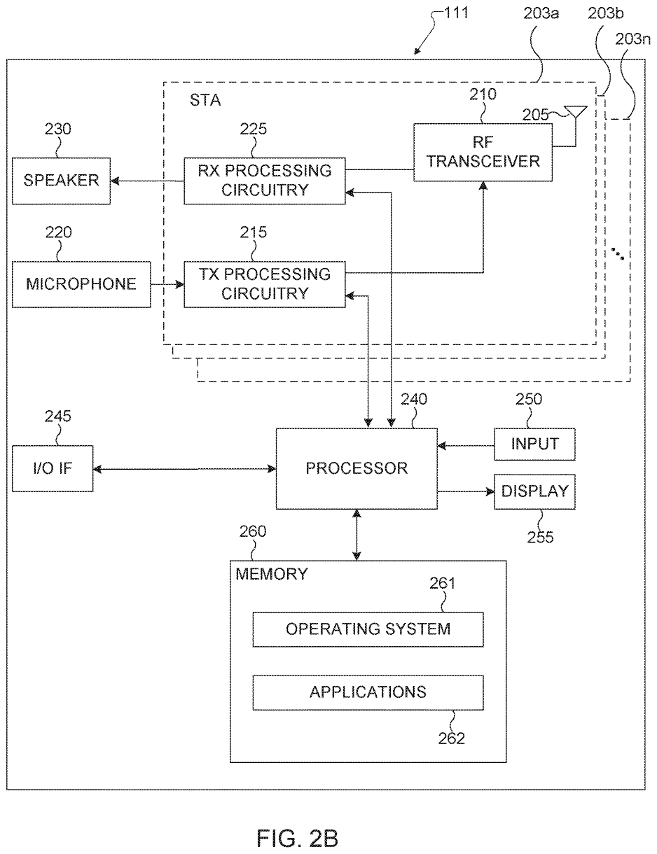

FIG. 2A illustrates an example AP device 101 according to various embodiments of the present disclosure. The embodiment of the AP device 101 illustrated in FIG. 2A is for illustration only, and the AP device 103 of FIG. 1 could have the same or similar configuration. In the embodiments discussed below, the AP device 101 is an AP device MLD. However, AP devices come in a wide variety of configurations, and FIG. 2A does not limit the scope of this disclosure to any particular implementation of an AP device.

The AP device MLD 101 is affiliated with multiple AP devices 202a-202n (which may be referred to, for example, as AP device1-APn). Each of the affiliated AP devices 202a-202n includes multiple antennas 204a-204n, multiple RF transceivers 209a-209n, transmit (TX) processing circuitry 214, and receive (RX) processing circuitry 219. The AP device MLD 101 also includes a controller/processor 224, a memory 229, and a backhaul or network interface 234.

The illustrated components of each affiliated AP device 202a-202n may represent a physical (PHY) layer and a lower media access control (LMAC) layer in the open systems interconnection (OSI) networking model. In such embodiments, the illustrated components of the AP device MLD 101 represent a single upper MAC (UMAC) layer and other higher layers in the OSI model, which are shared by all of the affiliated AP devices 202a-202n.

For each affiliated AP device 202a-202n, the RF transceivers 209a-209n receive, from the antennas 204a-204n, incoming RF signals, such as signals transmitted by STAs in the network 100. In some embodiments, each affiliated AP device 202a-202n operates at a different bandwidth, e.g., 2.4 GHz, 5 GHZ, or 6 GHZ, and accordingly the incoming RF signals received by each affiliated AP device may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP device 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP device 202a-202n operates at a different bandwidth, e.g., 2.4 GHz, 5 GHZ, or 6 GHz, the outgoing RF signals transmitted by each affiliated AP device may be at a different frequency of RF.

The controller/processor 224 can include one or more processors or other processing devices that control the overall operation of the AP device MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP device MLD 101 by the controller/processor 224 including anchor link design for multi-link operation. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP device MLD 101 to communicate with other devices or systems over a backhaul connection or over a network. The interface 234 could support communications over any suitable wired or wireless connection(s). For example, the interface 234 could allow the AP device MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP device MLD 101 may include circuitry and/or programming for supporting dynamic QoS profile switch in dynamic SCS. Although FIG. 2A illustrates one example of AP device MLD 101, various changes may be made to FIG. 2A. For example, the AP device MLD 101 could include any number of each component shown in FIG. 2A. As a particular example, an AP device MLD 101 could include a number of interfaces 234, and the controller/processor 224 could support routing functions to route data between different network addresses. As another particular example, while each affiliated AP device 202a-202n is shown as including a single instance of TX processing circuitry 214 and a single instance of RX processing circuitry 219, the AP device MLD 101 could include multiple instances of each (such as one per RF transceiver) in one or more of the affiliated AP devices 202a-202n. Alternatively, only one antenna and RF transceiver path may be included in one or more of the affiliated AP devices 202a-202n, such as in legacy AP devices. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a processor 240, an input/output (I/O) interface (IF) 245, an input 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP device of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHZ, or 6 GHz, the outgoing RF signals transmitted by each affiliated STA may be at a different frequency of RF.

The processor 240 can include one or more processors and execute the basic OS program 261 stored in the memory 260 in order to control the overall operation of the non-AP MLD 111. In one such operation, the processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to support dynamic QoS profile switch in dynamic SCS. In some embodiments, the processor 240 includes at least one microprocessor or microcontroller.

The processor 240 is also capable of executing other processes and programs resident in the memory 260, such as operations for supporting dynamic QoS profile switch in dynamic SCS dynamic QoS profile switch in dynamic SCS. The processor 240 can move data into or out of the memory 260 as required by an executing process. In some embodiments, the processor 240 is configured to execute a plurality of applications 262, such as applications for supporting dynamic QoS profile switch in dynamic SCS. The processor 240 can operate the plurality of applications 262 based on the OS program 261 or in response to a signal received from an AP device. The processor 240 is also coupled to the I/O interface 245, which provides non-AP MLD 111 with the ability to connect to other devices such as laptop computers and handheld computers. The I/O interface 245 is the communication path between these accessories and the processor 240.

The processor 240 is also coupled to the input 250 and the display 255. The operator of the non-AP MLD 111 can use the input 250 to enter data into the non-AP MLD 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted, and additional components could be added according to particular needs. In particular examples, one or more of the affiliated STAs 203a-203n may include any number of antenna(s) 205 for MIMO communication with an AP device 101. In another example, the non-AP MLD 111 may not include voice communication or the processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

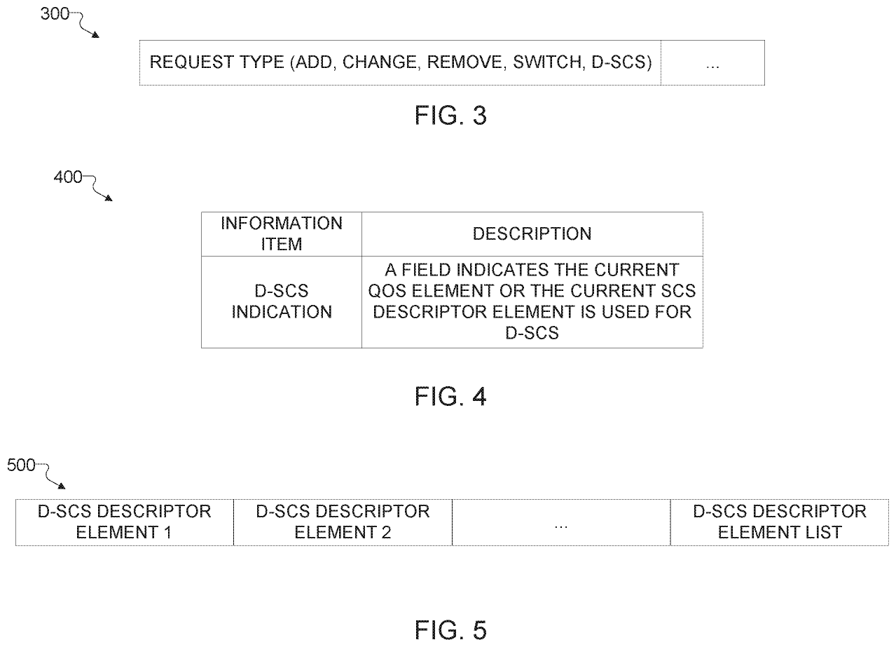

FIG. 3 illustrates an example D-SCS descriptor element 300 according to embodiments of the present disclosure. For ease of explanation, the D-SCS descriptor element 300 will be described as including one or more components of the wireless network 100 of FIG. 1, such as the AP device 101; however, the D-SCS descriptor element 300 could be implemented using any other suitable device or system. The embodiment of the D-SCS descriptor element 300 shown in FIG. 3 is for illustration only. Other embodiments of the D-SCS descriptor element 300 could be used without departing from the scope of this disclosure.

The Stream Classification Service (SCS) with Quality of Service (QoS) Characteristics procedure defined in IEEE 802.11be is designed for quasi-static traffic flow. The underlying assumption of this procedure is that traffic characteristics do not change too frequently. However, many scenarios exist in which user traffic patterns change at a high rate. To address this limitation, a detailed signaling mechanism for a dynamic SCS negotiation procedure is provided. This mechanism may allow a non-AP STA to dynamically change a QoS expectation or QoS flow with the associated AP device.

In one aspect of the disclosed subject matter, a first STA may send a dynamic SCS request frame to a second STA. Upon receiving the dynamic request frame, the second STA may respond to the first STA with a dynamic SCS response frame. The dynamic request and response frames may be variants of the SCS request and response frames.

In one aspect, the dynamic nature of the request may be indicated in the Robust Action field. In another aspect, one or more dynamic QoS Profiles may be indicated in one or more special SCS Descriptor elements. In a further aspect, one or more dynamic QoS Profiles may be indicated in one or more special QoS Characteristics elements.

A dynamic QoS Profile Info field may be included in one or more QoS Characteristics elements of the SCS frames. Similarly, a dynamic QoS Profile Info field may be included in one or more SCS Descriptor elements of the SCS frames. QoS Profile IDs may be supplemented in the dynamic SCS response frame to indicate the status of the corresponding profile. In one aspect, a new Status value may indicate acceptance of a dynamic QoS profile.

As shown in FIG. 3, the D-SCS descriptor element 300 may indicate the D-SCS in a field or subfield of the SCS descriptor list. For example, a bit set equal to 1 may indicate dynamic Quality of Service (QoS), while a bit set equal to 0 may indicate non-dynamic, pre-11bn QoS. Additionally, the Request Type may be set to “Switch” for dynamic QoS. Alternatively, the Request Type may be set to “Dynamic SCS.” Additionally or alternatively, a D-SCS indication field 400 that may indicate the D-SCS Descriptor is enabled, as shown in FIG. 4.

As shown in FIG. 5, a D-SCS descriptor list 500 (or a special SCS descriptor element) is reserved for D-SCS, for example, a D-SCS descriptor element. The positioning of the D-SCS descriptor list 500 may be set after the 11be SCS descriptor. In another embodiment, the positioning of the D-SCS descriptor list 500 is set at the beginning of the SCS descriptor list.

Although FIG. 3 illustrates one example of a D-SCS descriptor element, various changes may be made to FIG. 3. For example, various components of FIG. 3 could be combined, further subdivided, or omitted and additional components could be added according to particular needs. Similarly, various components of the D-SCS indication field of FIG. 4 could be combined, further subdivided, or omitted and additional components could be added according to particular needs. Although FIG. 5 illustrates one example of a D-SCS descriptor list, various changes may be made to FIG. 5. For example, various components of FIG. 5 could be combined, further subdivided, or omitted and additional components could be added according to particular needs.

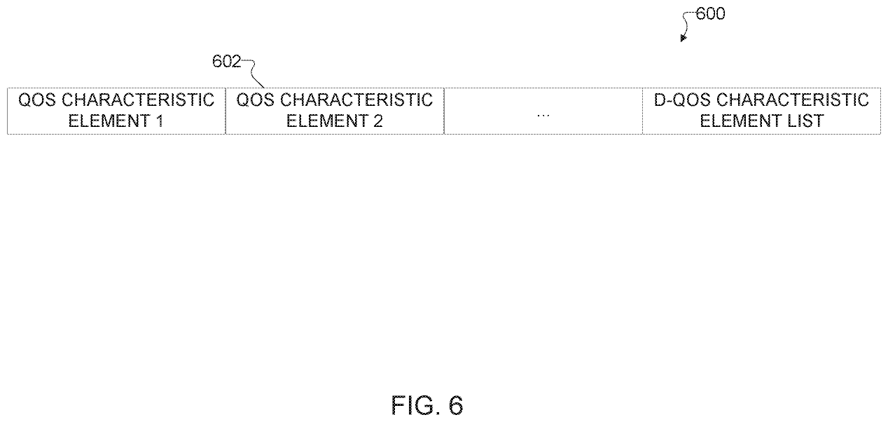

FIG. 6 illustrates an example D-SCS descriptor list 600 according to embodiments of the present disclosure. For ease of explanation, the D-SCS descriptor list 600 will be described as including one or more components of the wireless network 100 of FIG. 1, such as the AP device 101; however, the D-SCS descriptor list 600 could be implemented using any other suitable device or system. The embodiment of the D-SCS descriptor list 600 shown in FIG. 6 is for illustration only. Other embodiments of the D-SCS descriptor list 600 could be used without departing from the scope of this disclosure.

As shown in FIG. 6, the D-SCS descriptor list 600 may indicate the D-SCS in the QoS Characteristics Element 602. In one example of the embodiment, a bit or a set of bits in the Control Info field of the QoS Characteristics Element 602 is reserved for the D-QoS. According to a variant of this example, the Presence Bitmap of Additional Parameters within the Control Info field may serve as a position to indicate the D-QoS. In another variant, several reserved bits may be used for a D-SCS Indication field.

When the indication of the D-QoS is present in the Control Info field, the SCS descriptor list is listed in the SCS response frame as mandatory rather than optional. In one embodiment, a special QoS Characteristics Element 602 is reserved for Dynamic QoS. According to one embodiment, one or more QoS Characteristics Element 602s of one or more SCS Descriptor elements may be used for dynamic QoS, either sequentially or separately.

According to one variant of the embodiment, a dynamic QoS Characteristics or Dynamic QoS Profile with Element ID 255 and Element ID Extension 136 may be used for any set of dynamic QoS Profiles, as shown in Table 1. According to one embodiment, a field may be included in one or more QoS Characteristics for D-SCS enablement or indication.

TABLE 1
Element ID

| Element | Element ID | Extensible |
|---|---|---|
| D-QoS Characteristics or | 255 | 136 |
| Dynamic QoS Profile (see | | |
| 9.4.2.xxx) | | |

In one embodiment, the D-SCS may be indicated in the Robust Action field. One value of the Robust Action field is used for D-SCS Request, and another value is used for D-SCS Response, as shown for example in Table 2.

TABLE 2
Robust AV Streaming Robust Action Field

| Robust Action field value | Meaning |
|---|---|
| 6 | D-SCS Request |
| 7 | D-SCS Response |
| 8-255 | Reserved |

If the indication of D-SCS Request and Response is in the Robust AV streaming, the entire frame is reserved for the Dynamic QoS Profile. In another embodiment, if the QoS Characteristics Element 602 does not include a QoS Profile Info field, or the field is zero, a static 11be QoS is implied. If the indication is listed as part of the SCS Request frame, for example in the SCS Descriptor Element or in the QoS Characteristics Element 602, the SCS and D-SCS are mixed in the SCS Request frame, which may provide additional flexibility.

In another embodiment, D-SCS and SCS can be mixed to be indicated, as shown in Table 3.

TABLE 3
Robust AV Streaming Robust Action Field

| Robust Action field | |
|---|---|
| value | Meaning |
| 4 | SCS and/or D-SCS |
| | Request |
| 5 | SCS and/or D-SCS |
| | Response |
| 8-255 | Reserved |

Although FIG. 6 illustrates one example of a D-SCS descriptor list, various changes may be made to FIG. 6. For example, various components of FIG. 6 could be combined, further subdivided, or omitted and additional components could be added according to particular needs.

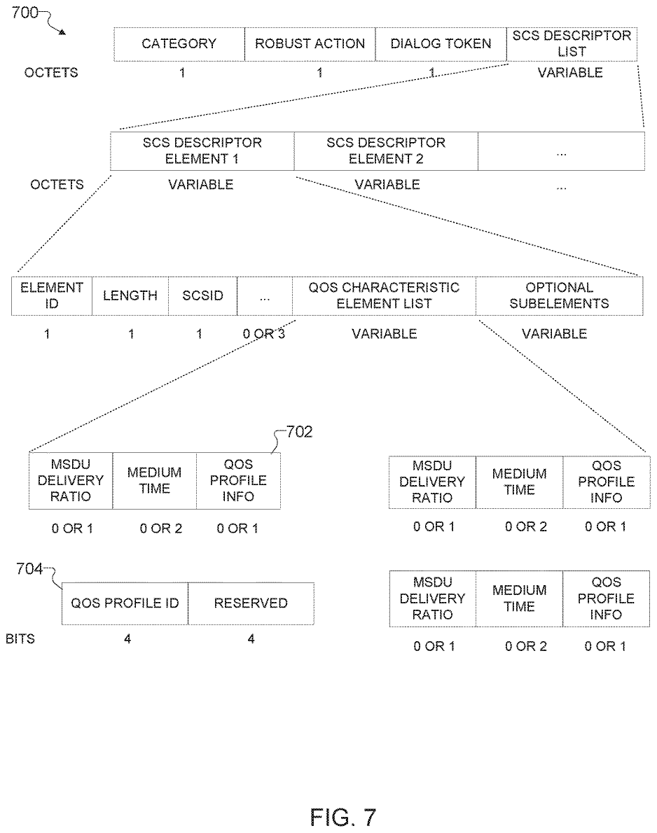

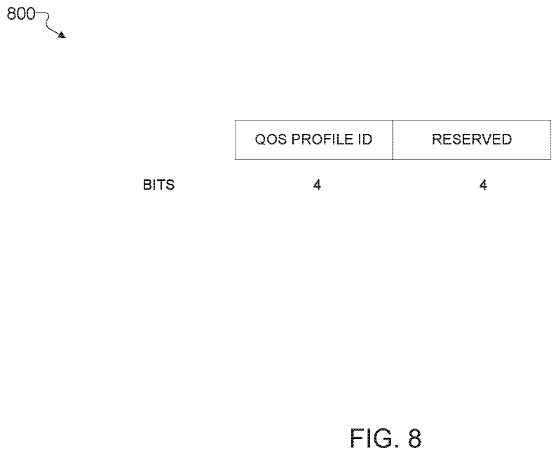

FIG. 7 illustrates an example QoS profile information 700 according to embodiments of the present disclosure. FIG. 8 illustrates an example QoS profile information field 800 according to embodiments of the present disclosure. For ease of explanation, the QoS profile information 700 will be described as including one or more components of the wireless network 100 of FIG. 1, such as the AP device 101; however, the QoS profile information 700 could be implemented using any other suitable device or system. The embodiment of the QoS profile information 700 shown in FIG. 7 is for illustration only. Other embodiments of the QoS profile information 700 could be used without departing from the scope of this disclosure.

As shown in FIG. 7, the QoS profile information 700 may have a QoS Profile Info field 702 that is added within one or more QoS Characteristic Elements contained in one or more SCS Descriptor Elements, each serving to label the QoS Profile. An example of this configuration is shown in FIG. 7.

In one embodiment, the Profile ID may be referenced using a single pointer ranging from 1 to N overall. According to another variant, the QoS Profile ID 704 may be referenced using two pointers, specifically an SCSID and a QoS Profile ID 704. In a further variant, the QoS Profile ID 704 may be referenced using one or more of the Element ID, SCSID, or QoS Profile ID 704, for example. In one embodiment, the QoS Profile Info field 702 may include the QoS Profile ID 704, the SCSID, the Element ID, and similar identifiers. An example of the QoS Profile Info field 702 800 is shown in FIG. 8.

The QoS Profile Info field 702 may be positioned within the Control Info field. According to one variant, the QoS Profile Info field 702 may instead be positioned at the end of the QoS Characteristic Element. According to another variant, the QoS Profile Info field 702 may be positioned at the end of the SCS Descriptor as an optional sub-element.

The number of QoS Profiles can be calculated by multiplying the number of SCS Descriptors by the number of QoS Characteristic Elements.

In one embodiment, the number, the maximum number, or the minimum number of QoS Profiles can be negotiated between the STA and the AP device. In another embodiment, the number, the maximum number, or the minimum number of QoS Profiles can be initiated by the AP device. The AP device may provide such information in management frames such as beacon frames, probe response frames, or SCS negotiation frames, for example. In a further variant, the AP device may provide such information in the UHR QoS Capabilities field, the QoS Characteristics Support field, or a related field. In yet another embodiment, the number, the maximum number, or the minimum number of QoS Profiles can be requested, suggested, or initiated by the STA. The maximum number of QoS Profiles may be included in the Optional Sub-Elements.

Although FIG. 7 illustrates one example of an QoS profile information, various changes may be made to FIG. 7. For example, various components of FIG. 7 could be combined, further subdivided, or omitted and additional components could be added according to particular needs. Similarly, various components of FIG. 8 could be combined, further subdivided, or omitted and additional components could be added according to particular needs.

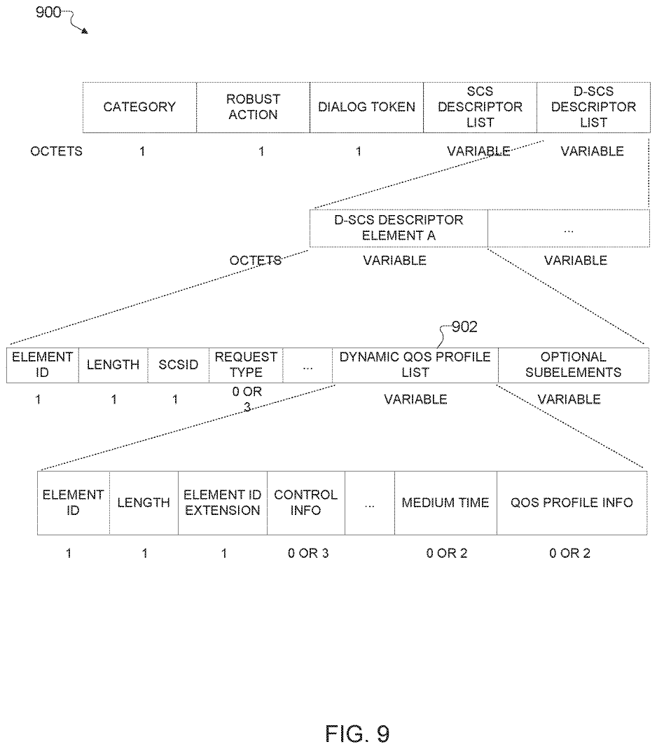

FIG. 9 illustrates an example mixed SCS and D-SCS request frame 900 according to embodiments of the present disclosure. For ease of explanation, the mixed SCS and D-SCS request frame 900 will be described as including one or more components of the wireless network 100 of FIG. 1, such as the AP device 101; however, the mixed SCS and D-SCS request frame 900 could be implemented using any other suitable device or system. The embodiment of the mixed SCS and D-SCS request frame 900 shown in FIG. 9 is for illustration only. Other embodiments of the mixed SCS and D-SCS request frame 900 could be used without departing from the scope of this disclosure.

As shown in FIG. 9, the mixed SCS and D-SCS request frame 900 may include a D-SCS request. When a D-SCS request is indicated in any field or subfield within one or more elements of the SCS Descriptor element list (such as the Element ID or subfields within the QoS Characteristics Element), certain SCS descriptor list entries may be retained while others may be revised as D-SCS descriptor list entries. For backward compatibility with a legacy STA, that device may be able to negotiate SCS parts, and devices that support D-SCS may negotiate both SCS and the new D-SCS.

In one embodiment, several special or specific SCS Descriptor Elements can be used as D-SCS Descriptor Elements. In one embodiment, a new Dynamic QoS Profile List 902 is designed as a new variant of the QoS Characteristics Element in the D-SCS Descriptor Element. One or more Dynamic QoS Profile elements may be listed in the Dynamic QoS Profile List 902. In one embodiment, the QoS Profile Info field may be appended to the QoS Characteristics Element.

Although FIG. 9 illustrates one example of a mixed SCS and D-SCS request frame, various changes may be made to FIG. 9. For example, various components of FIG. 9 could be combined, further subdivided, or omitted and additional components could be added according to particular needs.

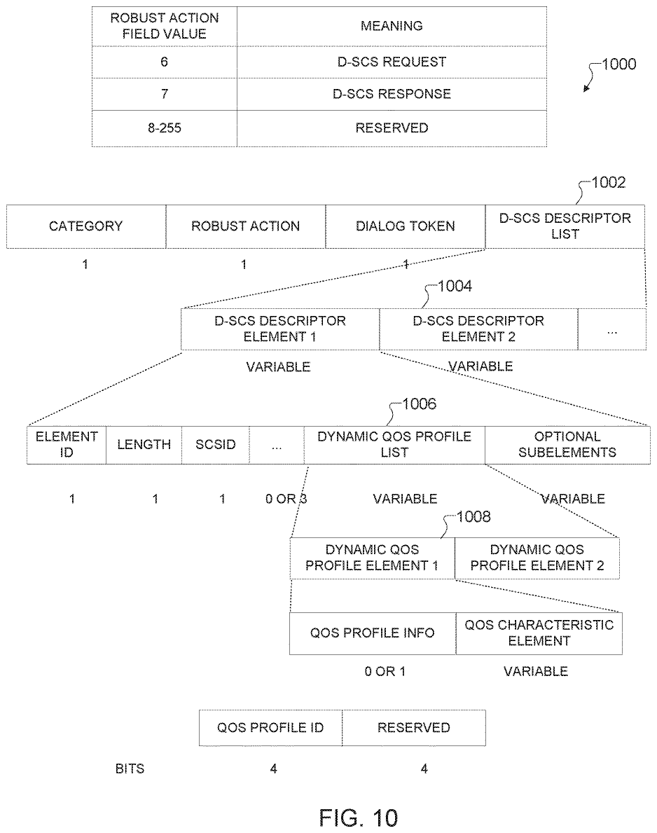

FIG. 10 illustrates an example D-SCS request frame 1000 according to embodiments of the present disclosure. For ease of explanation, the D-SCS request frame 1000 will be described as including one or more components of the wireless network 100 of FIG. 1, such as the AP device 101; however, the D-SCS request frame 1000 could be implemented using any other suitable device or system. The embodiment of the D-SCS request frame 1000 shown in FIG. 10 is for illustration only. Other embodiments of the D-SCS request frame 1000 could be used without departing from the scope of this disclosure.

As shown in FIG. 10, the D-SCS request frame 1000 includes a D-SCS request. If the D-SCS request is indicated in any field or subfield before the SCS Descriptor element list, for example, the Robust Action field, Dialog Token, or Category, the SCS descriptor list may be replaced or revised as the D-SCS descriptor list 1002 to maintain backward compatibility with the legacy STA. The legacy STA may not be able to read the new D-SCS and can skip the frame.

In one embodiment, the D-SCS descriptor list 1002 may include one or more D-SCS descriptor elements 1004. Each D-SCS descriptor element 1004 may include a Dynamic QoS Profile List 1006, which in turn may include one or more Dynamic QoS Profile elements 1008. The Dynamic QoS Profile Element may include QoS Profile Info, the QoS Characteristic Element, or both. The QoS Profile Info may include a QoS Profile ID and reserved bits.

Although FIG. 10 illustrates one example of a D-SCS request frame, various changes may be made to FIG. 10. For example, various components of FIG. 10 could be combined, further subdivided, or omitted and additional components could be added according to particular needs.

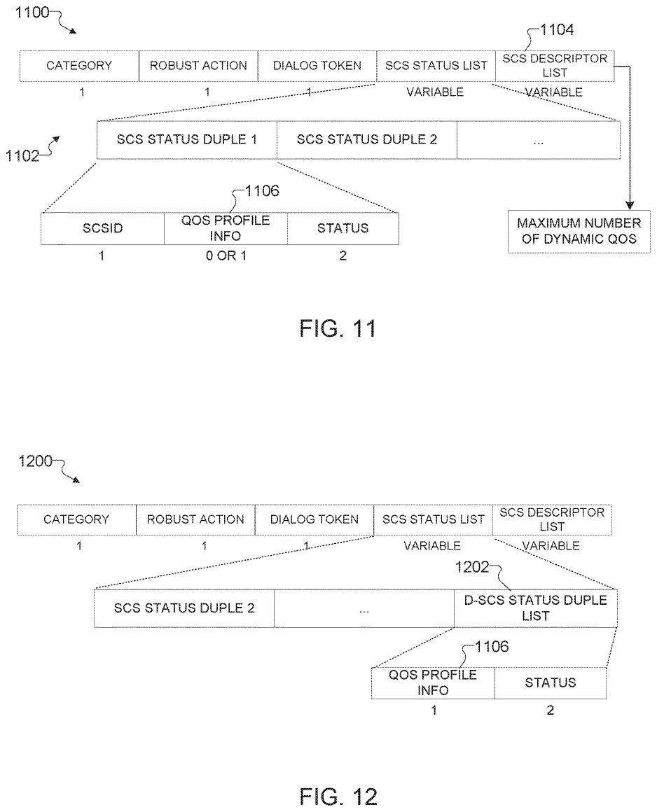

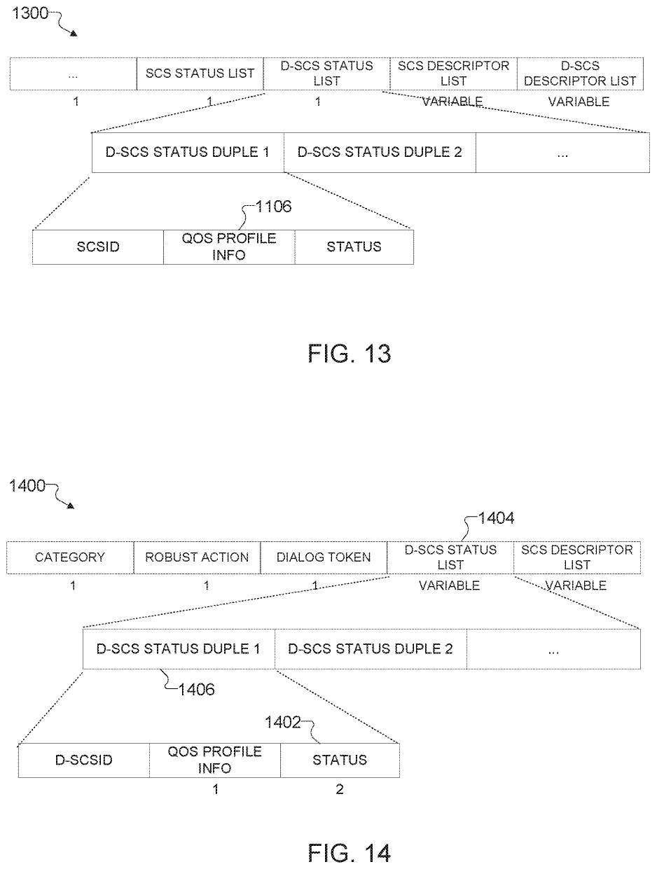

FIG. 11 illustrates an example QoS profile information field 1100 according to embodiments of the present disclosure. FIG. 12 illustrates an example QoS profile information field 1200 according to embodiments of the present disclosure. FIG. 13 illustrates an example SCS and D-SCS response frame 1300 according to embodiments of the present disclosure. For ease of explanation, the QoS profile information field 1100 will be described as including one or more components of the wireless network 100 of FIG. 1, such as the AP device 101; however, the QoS profile information field 1100 could be implemented using any other suitable device or system. The embodiment of the QoS profile information field 1100 shown in FIG. 11 is for illustration only. Other embodiments of the QoS profile information field 1100 could be used without departing from the scope of this disclosure.

As shown in FIG. 11, the QoS profile information field 1100 may be included in a request frame 1102. QoS Profile IDs may be supplemented in the dynamic SCS response frame. For example, QoS Profile IDs may be supplemented in the SCS Descriptor element or in the SCS Status List to indicate status. Additionally, QoS Profile IDs and corresponding Status values may be supplemented in the dynamic SCS response frame.

In one embodiment, the Dynamic QoS Profile Info may be considered in the SCS descriptor list 1104 corresponding to the position of the request frame.

In another embodiment, the QoS Profile Info field 1106 may be included in one or more SCS Status duple fields 1108. For example, the SCS Status duple element 1108 may include the QoS Profile Info field 1106, the SCSID, and the status field.

The one or more dynamic SCS status duples 1108 may include the QoS Profile Info field. In one embodiment, the QoS Profile Info field may be included in a new D-SCS Status duple list, which is a variant of the SCS Status duple list.

In one embodiment, the QoS Profile Info field 1106 may be included in one or more Dynamic SCS Status Duple Lists 1202 as shown in FIG. 12. The positioning of the D-SCS Status duple list 1202 may be at the end of the SCS Status List, at the beginning of the SCS Status List, or at a desired specific location.

According to another variant of the embodiment, the QoS Profile ID may be pointed using two pointers, namely the SCSID and the QoS Profile ID. In a further variant, the QoS Profile ID may be pointed using one or more of the Element ID, the SCSID, and the QoS Profile ID.

In one embodiment, the QoS Profile Info field 1106 may be included after the SCS Status List in the D-SCS Status duple list as shown in FIG. 13.

Although FIG. 11 illustrates one example of a QoS profile information field, various changes may be made to FIG. 11. For example, various components of FIG. 11 could be combined, further subdivided, or omitted and additional components could be added according to particular needs. Similarly, various components of FIGS. 12 and 13 could be combined, further subdivided, or omitted and additional components could be added according to particular needs.

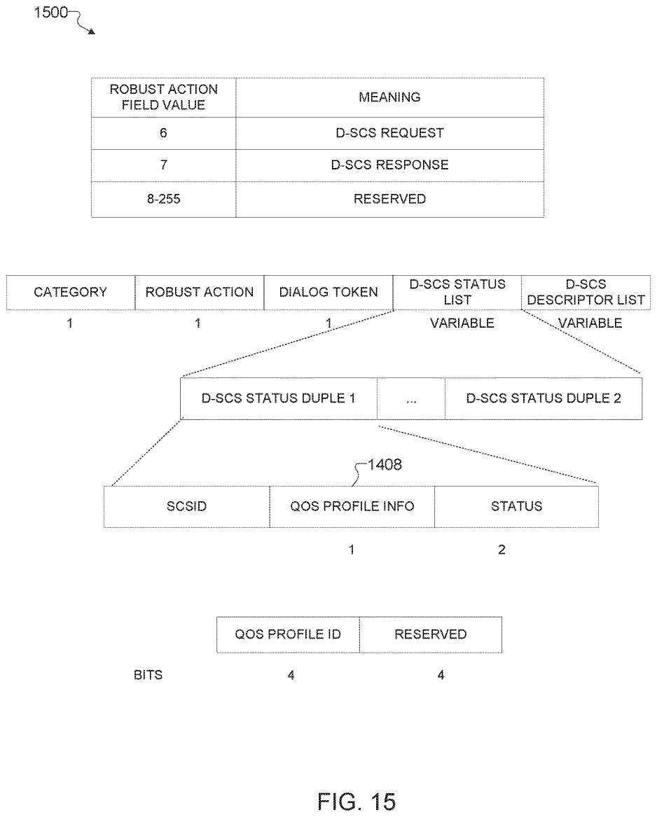

FIG. 14 illustrates an example D-SCS status list 1400 according to embodiments of the present disclosure. FIG. 15 illustrates an example D-SCS response frame 1500 according to embodiments of the present disclosure. For ease of explanation, the D-SCS status list 1400 will be described as including one or more components of the wireless network 100 of FIG. 1, such as the AP device 101; however, the D-SCS status list 1400 could be implemented using any other suitable device or system. The embodiment of the D-SCS status list 1400 shown in FIG. 14 is for illustration only. Other embodiments of the D-SCS status list 1400 could be used without departing from the scope of this disclosure.

As shown in FIG. 14, the D-SCS status list 1400 may include a status 1402. A new status 1402 may be configured as “ACCEPTABLE_DYNAMIC_QoS.” In one embodiment, the status code is equal to “ACCEPTABLE_DYNAMIC_QoS,” which indicates acceptance of all dynamic QoS requirements when the AP device is capable of supporting all such requirements. In another embodiment, the status code is equal to “ACCEPTABLE_DYNAMIC_QoS,” which indicates that the AP device will apply a best-effort approach. For example, the AP device may adjust overall service reliability to perform scheduling and allocate resources rather than dropping packets directly. This scenario is contemplated for worst-case conditions, such as when the AP device is forced to meet delay constraints of the highest profile for all packets.

If the D-SCS request and response are indicated in any field or subfield before the SCS Descriptor element list, for example, the Robust Action field, the Dialog Token, or the Category, then the SCS status list, the SCS descriptor list, or both may be replaced or revised as the D-SCS status list 1404 and the D-SCS descriptor list, respectively, for backward compatibility with legacy STAs. A legacy STA may not be able to read the new D-SCS and can skip the frame.

The D-SCS status list 1404 may include one or more D-SCS status duple elements 1406. Each D-SCS status duple element 1406 may include the D-SCSID, the QoS Profile Info field, and a corresponding status 1402. In one embodiment, the D-SCS status list 1404 includes one or more D-SCS Status duple elements. In one embodiment, the D-SCS status duple element 1406 includes the SCSID, the QoS Profile Info field, and the status 1402. The QoS Profile Info 1408 may include the QoS Profile ID and reserved bits as shown in FIG. 15.

Although FIG. 14 illustrates one example of a D-SCS status list, various changes may be made to FIG. 14. For example, various components of FIG. 14 could be combined, further subdivided, or omitted and additional components could be added according to particular needs. Additionally, various components of FIG. 15 could be combined, further subdivided, or omitted and additional components could be added according to particular needs.

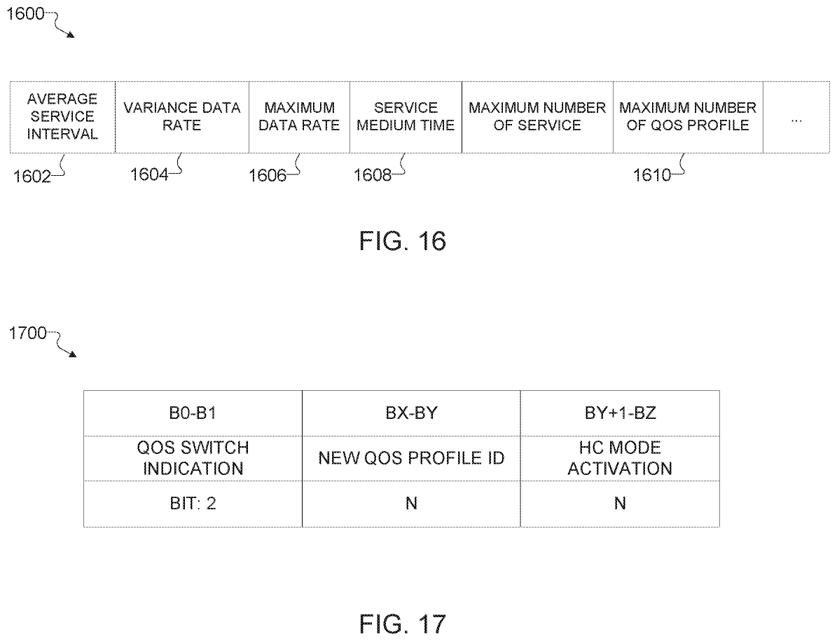

FIG. 16 illustrates an example QoS characteristics element 1600 according to embodiments of the present disclosure. FIG. 17 illustrates an example QoS profile indication 1700 according to embodiments of the present disclosure. For ease of explanation, the QoS characteristics element 1600 will be described as including one or more components of the wireless network 100 of FIG. 1, such as the AP device 101; however, the QoS characteristics element 1600 could be implemented using any other suitable device or system. The embodiment of the QoS characteristics element 1600 shown in FIG. 16 is for illustration only. Other embodiments of the QoS characteristics element 1600 could be used without departing from the scope of this disclosure.

As shown in FIG. 16, new information may be supplemented into the QoS characteristics element 1600 to enhance the characterization of dynamic quality of service. In another approach, one or more new information fields may replace existing fields rather than supplementing them. The information provides flexible characterization of traffic changes and patterns, including data rate, traffic duration, and frequency of occurrence. The new information characterizing the dynamic QoS may include one or more of the following elements, with an example of traffic patterns shown in FIG. 17.

Regarding the average service interval 1602, one approach provides an average interval for each QoS Profile, recognizing that the interval across different QoS Profiles may vary. A dynamic adjustment may apply to this value such that, rather than relying on a static average, stations could report expected variability or confidence ranges of the interval, particularly for bursty traffic. In a further approach, a histogram or percentage of service intervals over one application may be provided. This approach better informs schedulers whether the traffic is periodic, bursty, or erratic. Certain services, for example cloud gaming versus video streaming, might use similar intervals but exhibit different sensitivity to jitter, and the field may indicate the tolerance to interval deviation. Additionally, time-of-per-application variance may be considered statistically to report a service interval profile over a time cycle, which may help networks pre-provision resources.

Regarding the variance data rate 1604, the variance captures how much the data rate varies over time and helps characterize fluctuations in data rate, which is critical for understanding traffic patterns. In one variant, a normalized variance is incorporated into the dynamic QoS. The normalized variance may use a coefficient of variation, defined as the standard deviation divided by the mean, to fairly compare across different data rates. A rate phase pattern approach may combine the variance with TXOP or time windows to characterize rate ramp-up periods, plateaus, or idle bursts, which is useful for pre-buffering or predicting upcoming demands. As one example, high variance could trigger predictive algorithms in the AP device to pre-allocate or hold back resources.

Regarding the maximum or peak data rate 1606, this value may indicate the maximum or peak rate of one or more kinds of traffic. A peak duration context may also be considered. This parameter may provide the average duration of peak rate periods, for example brief spikes versus long saturation, which impacts scheduler backoff and buffer sizing. A further approach identifies both peak and sustainable rate over longer intervals or multiple TXOPs to differentiate flash bursts from heavy streams. A time-to-peak indicator can serve as a hint of how soon after flow start the peak is reached, helping to pre-allocate more bandwidth during initial moments, for example in cloud gaming or video buffering scenarios.

Regarding the service medium time 1608, a field may indicate the average duration of the service. The service medium time can be considered on a per-packet, per-burst, per-TXOP-duration, or per-application-statistic-traffic basis. The value can be used by the AP device to calculate fairness between stations. For example, the AP device may classify traffic with different service medium time values, distinguishing long medium times with low frequency from short times with high frequency as traffic bursts.

Regarding the maximum number of QoS Profiles 1610, this value may indicate the maximum number of QoS Profiles that the first station is willing to negotiate. In another approach, the AP device or the second station may provide this value. The first station or the second station may indicate preferred profiles among the maximum, for example the most important two of five, or even provide a ranking. In a further approach, the top few profiles are labeled as the most important profiles, and the second station may accept those with Accept or Success as the status code. For the remaining profiles, the second station can provide Accept with less resource support. The first station may expose thresholds to the second station indicating when the first station may drop some profiles, for example due to battery constraints, congestion, or application context changes. Negotiation hints may also be supported, allowing the station to suggest pairing, for example voice and video that are time-aligned, so that the AP device can co-schedule efficiently. An aggregation indication for the MAC layer or upper layer may specify whether the multiple profiles originate from the same application or session, for example video and audio of the same stream, or whether they are independent.

Regarding dynamic power save in D-SCS, the enablement stage operates as follows. A UHR non-AP station may enable and disable the Dynamic SCS with DPS mode when the associated AP device is a DPS Assisting AP device and a D-SCS supporting AP device. When a UHR non-AP station intends to enable the dynamic SCS in DPS mode with the associated AP device, mobile AP device, or a peer station, the non-AP station shall transmit a request frame, for example a Link Reconfiguration Request frame, with the DPS Mode field of the UHR Control field set to 1 and the D-SCS Mode field of the UHR Control field set to 1 to the AP device. The AP device may respond with a Response frame, for example a Link Reconfiguration Notify frame, to the non-AP station with the D-SCS Mode field set to 1 after the AP device is ready to serve the non-AP station in D-SCS with DPS mode. When a UHR non-AP station intends to disable the dynamic SCS in DPS mode with the associated AP device, mobile AP device, or a peer station, the non-AP station shall transmit a request frame, for example a Link Reconfiguration Request frame, with the DPS Mode field of the UHR Control field set to 0 and the D-SCS Mode field of the UHR Control field set to 0 to the AP device. In a variant, the UHR non-AP station may disable the DPS mode in dynamic SCS but keep D-SCS active by setting the DPS Mode field equal to 0 and the D-SCS Mode field equal to 1, or vice versa. The AP device may respond with a Response frame, for example a Link Reconfiguration Notify frame, to the non-AP station with the D-SCS Mode field set to 0 after the AP device is no longer serving the non-AP station in D-SCS with DPS mode.

During the negotiation stage, stations may indicate active mode or power-hungry mode to trade latency or bandwidth for battery savings in energy-aware QoS. Stations may negotiate low capability (LC) mode and high capability (HC) mode in the dynamic QoS negotiation procedure. For example, a higher peak data rate may indicate a need to transition to HC mode, and a lower peak rate may indicate a return to LC mode. A threshold or specific number relating to bandwidth, number of streams, MCS, or similar parameters may be used to classify LC and HC. Two sets of primary and secondary QoS Profiles may be classified for LC and HC, and the classification of the sets may be based on the differences between them. The QoS Characteristics may include HC mode DPS, LC mode DPS, DPS enablement, parameterized DPS, and similar parameters in the negotiation frames, such as the D-SCS request or response frame.

Regarding the indication stage, where the AP device, mobile AP device, or DPS assisting station solicits the needs of QoS Profiles, a station may indicate a need to switch from an LC mode transition in a lower QoS Profile to a higher QoS Profile with HC mode. For example, the indication of the switch may be included in an ICR, such as a Multi-STA BA, where a field serving as DPS activation, DPS transition, or DPS enablement is set to 1. This field may be located in a specific field such as the User Info field. This field may also be located in the QoS Profile indicating the need from the station requesting a higher QoS Profile. An example is shown in FIG. 4. When a higher QoS is needed, a QoS Switch indication may be set to one, the new QoS Profile ID is updated in the ICR, and the HC mode activation is set to 1. Additional field values such as LC mode activation, HC mode deactivation, LC mode deactivation, DPS enablement, and DPS disablement may also be considered.

The AP device, mobile AP device, or DPS assisting station may automatically transition from LC mode to HC mode after receiving the indication. After the D-SCS indication frame exchange, the AP device, mobile AP device, or DPS assisting station may solicit the transition of the peer DPS station to HC mode by sending an ICR. The ICF, such as a BSRP or MU-RTS, may include the D-SCS with DPS Switch request or indication. For example, the BSRP soliciting a QoS switch addressed to the DPS station may include an intermediate FCS (i-FCS) field if the DPS station has indicated a non-zero DPS padding delay and may include sufficient padding. In another approach, the frame may include D-SCS and DPS independently, for example in different User Info fields where one of the User Info fields may include an i-FCS field.

The D-SCS may function as an LC power state of DPS, which is applicable to parameterized DPS mode. Alternatively, D-SCS may function as an HC power state of DPS. The DPS station in HC mode may transition back to LC mode under one or more of the following conditions. The first condition is when the QoS Profile is updated with a low QoS Profile. The second condition is when the default QoS Profile is set as LC mode and the high QoS Profile has finished or ended. The third condition is when the QoS session is over.

Additional information that may be considered in the dynamic QoS includes the following. Stations may indicate whether the traffic is real-time, interactive, buffered, or elastic, which can be layered over the existing QoS Profile. Stations may indicate a Service Disruption Tolerance, which includes the number of tolerated consecutive drops or delays. For example, gaming may tolerate one frame loss every 500 milliseconds but not two consecutive losses. Stations could also support feedback-based adaptation. For example, the second station or the D-SCS responder station can request to reduce rate, pause, or reassign profiles dynamically.

Regarding new information in the dynamic switch indication, the information described in the preceding sections may also be included during the QoS switch session. Over the course of switching the QoS Profile, one or more values or a tuple such as the set of X1, X2, and X3 can be indicated for a quick switch. The information of the dynamic QoS that can be considered is listed in Table 1. The station can be triggered to use the appropriate QoS Profile when the application or middle layer provides more information about the traffic pattern. For example, in an online gaming scenario, the game developer or the application layer may indicate that the ongoing stage is in a combating zone due to multiple players approaching closely, or may indicate that the user will be entering the respawn stage or event of the game. Based on this information, the station can determine which profile to use.

Although FIG. 16 illustrates one example of a QoS characteristics element, various changes may be made to FIG. 16. For example, various components of FIG. 16 could be combined, further subdivided, or omitted and additional components could be added according to particular needs. Additionally, various components of FIG. 17 could be combined, further subdivided, or omitted and additional components could be added according to particular needs.

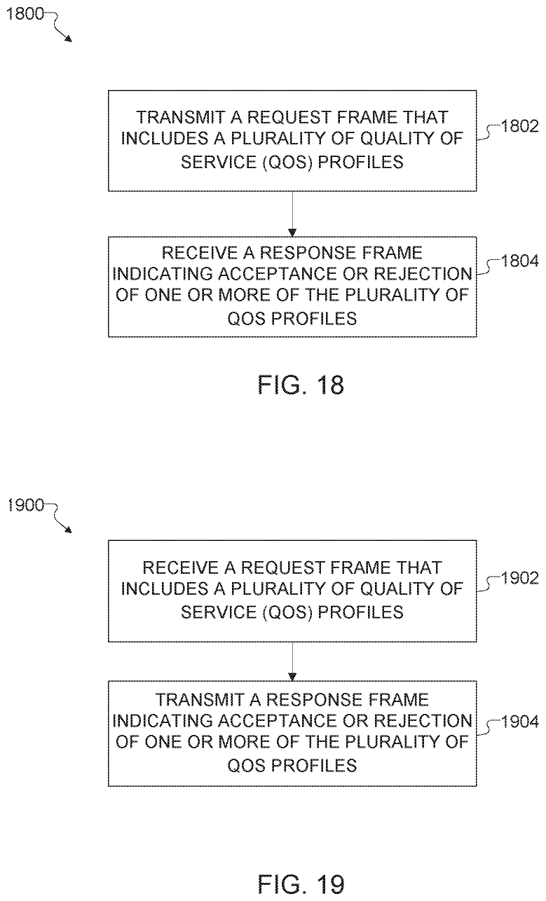

FIG. 18 illustrates an example method 1800 performed by a non-access point station for a dynamic SCS negotiation procedure according to embodiments of the present disclosure. An embodiment of the method illustrated in FIG. 18 is for illustration only. One or more of the components illustrated in FIG. 18 may be implemented in specialized circuitry configured to perform the noted functions or one or more of the components may be implemented by one or more processors executing instructions to perform the noted functions. Other embodiments of dynamic SCS negotiation procedure could be used without departing from the scope of this disclosure.

As shown in FIG. 18, a request frame is transmitted to an associated AP device that includes a plurality of quality of service (QoS) profiles at step 1802. For example, a STA 111 may transmit a request frame that includes a request for D-SCS to an AP device 101. The request frame may include a plurality of QoS profiles for use in D-SCS.

A response frame is received from the AP device where the response frame indicating acceptance or rejection of one or more of the plurality of QoS profiles at step 1804. For example, the STA 111 may receive a response frame that indicates acceptance or rejection of the plurality of QoS profiles for D-SCS from the AP device 101.

Although FIG. 18 illustrates one example method performed by a non-access point station for a dynamic SCS negotiation procedure, various changes may be made to FIG. 18. For example, while shown as a series of steps, various steps in FIG. 18 could overlap, occur in parallel, occur in a different order, or occur any number of times.

FIG. 19 illustrates an example method 1900 performed by an access point device for a dynamic SCS negotiation procedure according to embodiments of the present disclosure. An embodiment of the method illustrated in FIG. 19 is for illustration only. One or more of the components illustrated in FIG. 19 may be implemented in specialized circuitry configured to perform the noted functions or one or more of the components may be implemented by one or more processors executing instructions to perform the noted functions. Other embodiments of dynamic SCS negotiation could be used without departing from the scope of this disclosure.

As shown in FIG. 19, a request frame is received from an associated non-AP STA that includes a plurality of quality of service (QoS) profiles at step 1902. For example, an AP device 101 may receive a request frame from a STA 111 that includes a plurality of QoS profiles for use in a D-SCS stream.

A response frame is transmitted to the non-AP STA where the response frame indicating acceptance or rejection of one or more of the plurality of QoS profiles at step 1904. For example, the AP device 101 may transmit a response frame that includes acceptance or rejection of the QoS profiles for D-SCS.

Although FIG. 19 illustrates one example method performed by an access point device for a dynamic SCS negotiation procedure, various changes may be made to FIG. 19. For example, while shown as a series of steps, various steps in FIG. 19 could overlap, occur in parallel, occur in a different order, or occur any number of times.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a non-access point (AP) station (STA), the method comprising:
transmitting, to an associated AP device, a request frame that includes a plurality of quality of service (QoS) profiles, wherein each QoS profile of the plurality of QoS profiles:
includes one or more QoS characteristics elements; and
is identified by a unique QoS profile identifier (ID), wherein the plurality of QoS profiles are listed within the request frame; and
receiving, from the AP device, a response frame where the response frame indicating SUCCESS or REJECT of one or more of the plurality of QoS profiles.

2. The method of claim 1, wherein the response frame includes a Status field of SUCCESS or REJECT associated with each QoS profile ID, the status field indicating acceptance or rejection of the corresponding QoS profile in responding to the request frame.

3. The method of claim 1, wherein:
each of the QoS profile IDs is assigned to a QoS characteristics element that is associated to one stream classification service (SCS) ID and wherein multiple QoS characteristics elements are assigned across one or multiple stream classification service (SCS) streams with different SCSIDs; or
the QoS profile ID is unique within a corresponding SCSID, wherein each SCSID is associated with one or more QoS profiles and the QoS profile ID is assigned independently.

4. The method of claim 1, wherein the plurality of QoS profiles are carried by QoS profile IDs for a corresponding QoS characteristics element within one or more SCS descriptor elements.

5. The method of claim 1, wherein the one or more QoS profiles are identified by unique QoS profile IDs for a corresponding QoS characteristics element in a dynamic SCS descriptor element appended to the SCS descriptor elements.

6. The method of claim 1, wherein the response frame with one or more QoS profile IDs is configured to indicate a status of the corresponding QoS profiles.

7. The method of claim 6, wherein the status indicated in a dynamic SCS status duple of the response frame may indicate acceptance or rejection of the QoS profile ID corresponding to the QoS characteristics element.

8. The method of claim 1, wherein one or more information can be considered in the QoS characteristics element, wherein the one or more information includes a peak data rate, a maximum number of QoS profile, a service medium time, an average service interval, or a combination thereof.

9. A method performed by an access point (AP) device, the method comprising:
receiving, from an associated non-AP station (STA), a request frame that includes a plurality of quality of service (QoS) profiles, wherein each QoS profile of the plurality of QoS profiles:
includes one or more QoS characteristics elements; and
is identified by a unique QoS profile identifier (ID), wherein the plurality of QoS profiles are listed within the request frame; and
transmitting, to the non-AP STA, a response frame where the response frame indicating SUCCESS or REJECT of one or more of the plurality of QoS profiles.

10. The method of claim 9, wherein the response frame includes a Status field of SUCCESS or REJECT associated with each QoS profile ID, the status field indicating acceptance or rejection of the corresponding QoS profile in responding to the request frame.

11. The method of claim 9, wherein:
each of the QoS profile IDs is assigned to a QoS characteristics element that is associated to one stream classification service (SCS) ID and wherein multiple QoS characteristics elements are assigned across one or across multiple stream classification service (SCS) streams with different SCSIDs; and
the QoS profile ID is unique within a corresponding SCSID, wherein each SCSID is associated with one or more QoS profiles and the QoS profile ID is assigned independently.

12. The method of claim 9, wherein the plurality of QoS profiles are carried by QoS profile IDs for a corresponding QoS characteristics element within one or more SCS descriptor elements.

13. The method of claim 9, wherein the one or more QoS profiles are identified by unique QoS profile IDs for a corresponding QoS characteristics element in a dynamic SCS descriptor element appended to the SCS descriptor elements.

14. The method of claim 9, wherein the response frame with one or more QoS profile IDs is configured to indicate a status of the corresponding QoS profiles.

15. The method of claim 14, wherein the status indicated in a dynamic SCS status duple of the response frame may indicate acceptance or rejection of the QoS profile ID corresponding to the QoS characteristics element.

16. The method of claim 9, wherein one or more information can be considered in the QoS characteristics element, wherein the one or more information includes a peak data rate, a maximum number of QoS profile, a service medium time, an average service interval, or a combination thereof.

17. An electronic device comprising:
a transceiver; and
a processor operatively coupled to the transceiver, the processor configured to cause the electronic device to:
transmit, to an associated AP device, a request frame that includes a plurality of quality of service (QoS) profiles, wherein each QoS profile of the plurality of QoS profiles:
includes one or more QoS characteristics elements; and
is identified by a unique QoS profile identifier (ID), wherein the plurality of QoS profiles are listed within the request frame; and
receive, from the AP device, a response frame where the response frame indicating SUCCESS or REJECT of one or more of the plurality of QoS profiles.

18. The electronic device of claim 17, wherein the response frame includes a Status field of SUCCESS or REJECT associated with each QoS profile ID, the status field indicating acceptance or rejection of the corresponding QoS profile in responding to the request frame.

19. The electronic device of claim 17, wherein:
each of the QoS profile IDs is assigned to a QoS characteristics element that is associated to one stream classification service (SCS) ID and wherein multiple QoS characteristics elements are assigned across one or across multiple stream classification service (SCS) streams with different SCSIDs; and
the QoS profile ID is unique within a corresponding SCSID, wherein each SCSID is associated with one or more QoS profiles and the QoS profile ID is assigned independently.

20. The electronic device of claim 17, wherein the response frame with one or more QoS profile IDs is configured to indicate a status of the corresponding QoS profiles and wherein the status indicated in a dynamic SCS status duple of the response frame may indicate acceptance or rejection of the QoS profile ID corresponding to the QoS characteristics element.
